(19) United States
(12) Patent Application Publication
(10) Pub. No.: US 2018/0054617 A1
(43) Pub. Date: Feb. 22, 2018

(54) IMAGE CODING DEVICE AND METHOD

(71) Applicant: SONY CORPORATION, TOKYO (JP)

(72) Inventor: KAZUYA OGAWA, TOKYO (JP)

(21) Appl. No.: 15/560,248

(22) PCT Filed: Mar. 16, 2016
(86) PCT No.: PCT/JP2016/058266

§ 371 Date: Sep. 21, 2017

(30) Foreign Application Priority Data
Mar. 30, 2015 (JP) 2015-068152

(51) Int. Cl. H04N 19/156; H04N 19/107; H04N 19/117; H04N 19/13; H04N 19/124; H04N 19/109; H04N 19/105

(52) U.S. Cl. CPC H04N 19/156; H04N 19/107; H04N 19/117; H04N 19/105; H04N 19/124; H04N 19/109; H04N 19/13

(57) ABSTRACT

The present disclosure relates to an image coding device and a method that permit stable transfer of image data for long hours. A budget determination part generates power/band budget information, information serving as a basis for coding process control, using, as inputs, power output information, remaining battery charge information, and communicable band information and supplies the generated power/band budget information to a coding control section. The coding control section generates an image coding scheme and coding parameter/mode from the power/band budget information from the budget determination part and supplies compression control information including the image coding scheme and the coding parameter/mode to an image compression device. The present disclosure is applicable, for example, to a camera system that handles coding.

### TECHNICAL FIELD

The present disclosure relates to an image coding device and a method, and more particularly, to an image coding device and a method that permit stable transfer of image data for long hours.

### BACKGROUND ART

As a camera system of the Internet of things (IoT) age that can be installed anywhere and that permits acquisition of video data, a camera system has been proposed that includes a power generation device and a wireless communication section and requires no power channel or wired communication channel.

For example, PTL 1 proposes an imaging device that includes a power generation device and a wireless communication function. The imaging device can shoot for long hours by changing an image shooting, a shooting frequency, and a compression ratio in accordance with an average power output.

### CITATION LIST

### Patent Literature

[PTL 1]
JP 2011-228884 A

### SUMMARY

### Technical Problem

However, this proposal has led to reduced image area, shooting frequency, and image quality in exchange for continuation of shooting.

The present disclosure has been devised in light of such circumstances, and an object of the present disclosure is to permit stable transfer of image data for long hours.

### Solution to Problem

An image coding device according to an aspect of the present disclosure includes a coding section, a coding control section, and a transmission section. The coding section generates coded data by performing a coding process on image data. The coding control section controls the coding process in accordance with power information on power. The transmission section transmits coded data generated by the coding section.

The power information can include at least one of information indicating a power output generated and remaining charge information of a battery that stores power.

The coding control section can switch between coding schemes used for the coding process.

The coding control section can switch between intra-prediction and inter-prediction for the coding scheme used for the coding process.

The coding control section can switch between coding control parameters used for the coding process.

The coding control section can switch between a uni-directional prediction mode and a bi-directional prediction mode as the coding control parameter if inter-prediction is used.

The coding control section can switch between numbers of reference planes as the coding control parameter if inter-prediction is used.

The coding control section can switch between sizes of a motion prediction search range as the coding control parameter if inter-prediction is used.

The coding control section can switch between enabling and disabling a deblocking filter as the coding control parameter.

The coding control section can switch between enabling and disabling at least one of a deblocking filter and an adaptive offset filter as the coding control parameter.

The coding control section can switch a variable length coding process between context-adaptive binary arithmetic coding (CABAC) and context-adaptive variable length coding (CAVLC) as the coding control parameter.

The coding control section can switch between lower limits of a predictive block size as the coding control parameter.

The transmission section can wirelessly transmit coded data generated by the coding section, and the coding control section can control the coding process in accordance with information representing a band over which the transmission section can communicate.

An image coding method according to an aspect of the present disclosure causes an image coding device to generate coded data by performing a coding process on image data, control the coding process in accordance with power information on power, and transmit generated coded data.

In an aspect of the present disclosure, coded data is generated by performing a coding process on image data, and the coding process is controlled in accordance with power information on power. Then, generated coded data is transmitted.

It should be noted that the above image coding device may be an independent image coding device or an internal block making up a single image coding device.

### Advantageous Effects of Invention

According to an aspect of the present disclosure, it is possible to code images. Particularly, it is possible to stably transfer image data for long hours.

It should be noted that the effects described here are not restrictive and may be any one of the effects described in the present disclosure.

### BRIEF DESCRIPTION OF DRAWINGS

FIG. 1 is a block diagram illustrating a configuration example of a camera system to which the present technology is applied.

FIG. 2 is a block diagram illustrating a configuration example of a budget determination/coding control section.

FIG. 3 is a block diagram illustrating a configuration example of an image compression device.

FIG. 4 is a flowchart describing processes handled by a camera system.

FIG. 5 is a flowchart describing a budget determination process.

FIG. 6 is a diagram illustrating an example of power budget information.

FIG. 7 is a diagram illustrating an example of power/band budget information.

FIG. 8 is a flowchart describing a coding control process handled by a coding control part.

FIG. 9 is a flowchart describing a coding process handled by an image compression device.

FIG. 10 is a flowchart describing the coding process handled by the image compression device.

FIG. 11 is a flowchart describing another example of the coding control process.

FIG. 12 is a flowchart describing still another example of the coding control process.

FIG. 13 is a flowchart describing another example of the budget determination process.

FIG. 14 is a diagram illustrating an example of power budget information.

FIG. 15 is a diagram illustrating an example of power/band budget information.

FIG. 16 is a flowchart describing the coding control process when the budget determination process illustrated in FIG. 13 is performed.

FIG. 17 is a flowchart describing still another example of the budget determination process.

FIG. 18 is a flowchart describing the coding control process when the budget determination process illustrated in FIG. 17 is performed.

FIG. 19 is a flowchart describing still another example of the budget determination process.

FIG. 20 is a diagram illustrating an example of band budget information.

FIG. 21 is a flowchart describing the coding control process when the budget determination process illustrated in FIG. 19 is performed.

FIG. 22 is a block diagram illustrating another configuration example of the camera system to which the present technology is applied.

FIG. 23 is a block diagram illustrating another configuration example of the camera system to which the present technology is applied.

FIG. 24 is a block diagram illustrating another configuration example of the camera system to which the present technology is applied.

FIG. 25 is a block diagram illustrating a hardware configuration example of a computer.

### DESCRIPTION OF EMBODIMENTS

Modes for carrying out the present disclosure (hereinafter referred to as embodiments) will be described below. It should be noted that the description will be given in the following order:

1. First embodiment (camera system)
2. Second embodiment (camera system)
3. Third embodiment (camera system)
4. Fourth embodiment (camera system)
5. Fifth embodiment (computer)

### 1. First Embodiment

### (Configuration Example of Camera System)

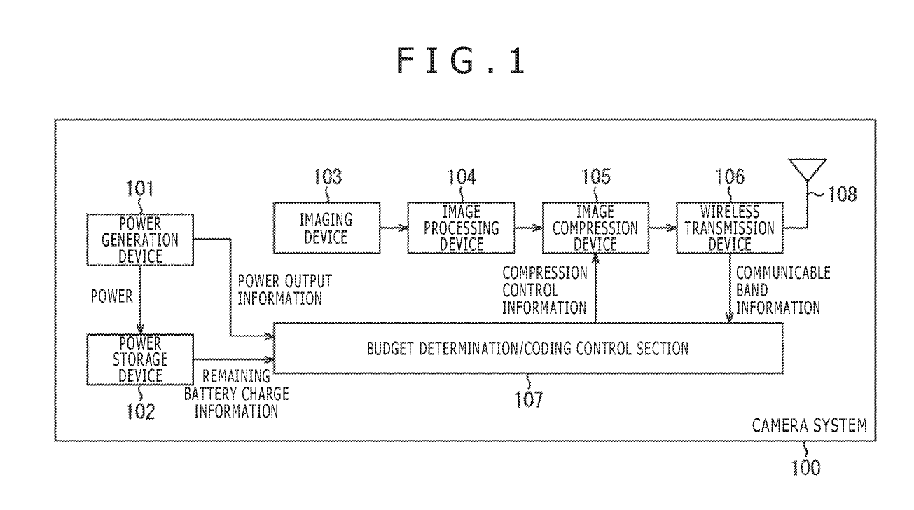

FIG. 1 is a block diagram illustrating a configuration example of a camera system to which the present technology is applied.

A camera system 100 is configured to include a power generation device 101, a power storage device 102, an imaging device 103, an image processing device 104, an image compression device 105, a wireless transmission device 106, and a budget determination/coding control section 107.

The power generation device 101 is a device that generates power from fuels or natural energies such as vibration and light. For example, the power generation device 101 may be a solar panel, a device that generates power from vibration, a device that generates power from pressure, a device that generates power from heat, or a device that generates power from electromagnetic waves.

Power from the power generation device 101 is sent to the power storage device 102. Also, the power generation device 101 supplies power output information, information on power output, to the budget determination/coding control section 107.

The power storage device 102 stores power generated by the power generation device 101. The power storage device 102 supplies remaining battery charge information, information on remaining battery charge, to the budget determination/coding control section 107.

The imaging device 103 includes, for example, a complementary metal oxide semiconductor (CMOS) solid-state imaging device, a charge coupled device (CCD) solid-state imaging device, an analog-to-digital (A/D) conversion device, and so on and acquires image data by imaging a subject. The imaging device 103 outputs acquired image data to the image processing device 104.

The image processing device 104 performs image processing on the image data from the imaging device 103 other than image compression such as pixel and color correction and distortion correction and outputs image data subjected to image processing to the image compression device 105.

The image compression device 105 performs a coding process (compression process) on the image data from the image processing device 104 based on an image coding algorithm using compression control information from the budget determination/coding control section 107. Among examples of the image coding algorithm are Joint Photographic Experts Group (JPEG), Moving Picture Experts Group (MPEG), H.246/advanced video coding (AVC) (hereinafter referred to as H.264), and H.265/high efficiency video coding (HEVC) (hereinafter referred to as H.265). The image compression device 105 outputs data, whose amount has been reduced by coding, to the wireless transmission device 106.

The wireless transmission device 106 receives coded data from the image compression device 105 and transmits the data wirelessly via an antenna 108. Also, the wireless transmission device 106 supplies communicable band information containing a communicable band to the budget determination/coding control section 107.

The budget determination/coding control section 107 generates information for controlling the coding process handled by the image compression device 105 using, as inputs, power output information of the power generation device 101, remaining battery charge information of the power storage device 102, and communicable band information of the wireless transmission device 106. The budget determination/coding control section 107 may be, for example, a central processing unit (CPU) or a program that runs on the CPU.

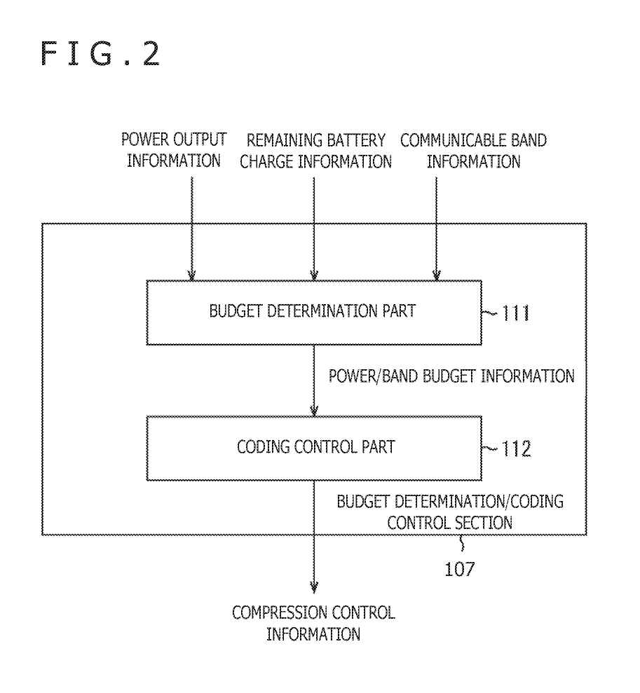

The budget determination/coding control section 107 includes a budget determination part 111 and a coding control part 112 as illustrated in FIG. 2. The budget determination part 111 generates power/band budget information, information serving as a basis for coding process control, using, as inputs, not only power information including at least one of power output information and remaining battery charge information but also communicable band information and supplies the generated power/band budget information to the coding control part 112. The coding control part 112 generates an image coding scheme and coding parameter/mode from the power/band budget information from the budget determination part 111 and supplies compression control information including the image coding scheme and the coding parameter/mode to the image compression device 105. That is, the coding control part 112 controls the image compression device 105 and causes the image compression device 105 to switch between image coding schemes and coding parameters/modes in accordance with the power/band budget information from the budget determination part 111.

### (Configuration Example of Image Compression Device)

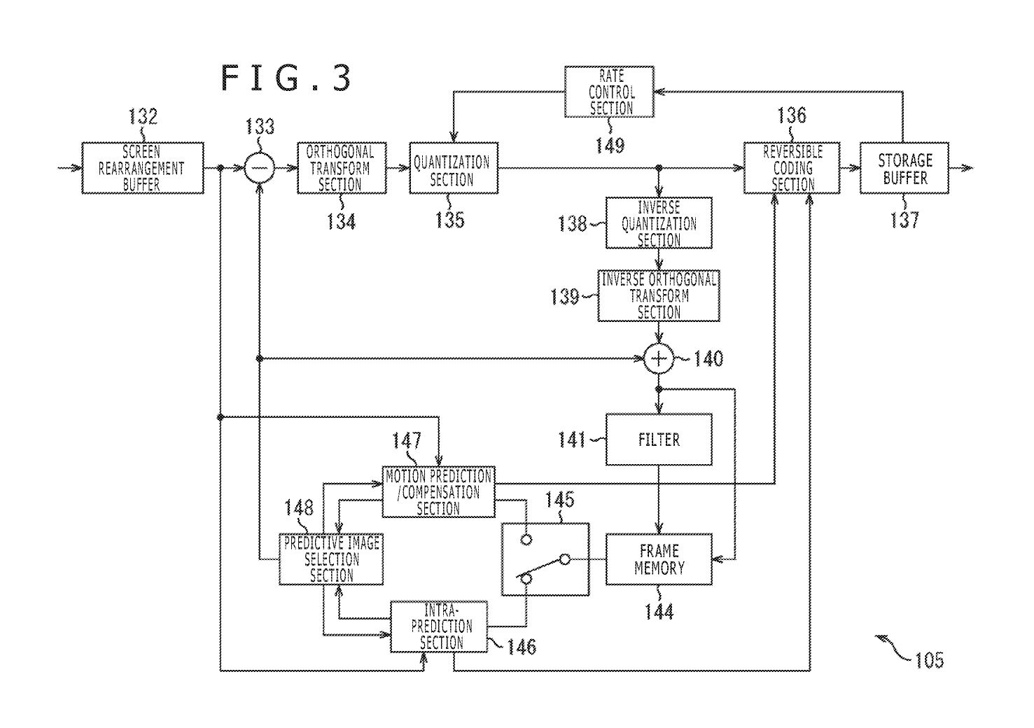

FIG. 3 is a block diagram illustrating a configuration example of the image compression device. It should be noted that the example of FIG. 3 depicts an example in which the image coding scheme is H.265 as an example.

In a conventional coding schemes such as MPEG2 or H.264, the coding process is performed in units of processes called macroblocks. A macroblock is a block having a uniform size of 16×16 pixels. In H.265, on the other hand, the coding process is performed in units of processes called coding units (CUs). A CU is a block having a variable size formed by recursively dividing the largest coding unit (LCU). The maximum selectable size of a CU is 64×64 pixels. The minimum selectable size of a CU is 8×8 pixels. The minimum size CU is called the smallest coding unit (SCU).

Thus, as a result of selection of CUs having a variable size, H.265 permits adaptive adjustment of image quality and coding efficiency in accordance with details of the image. A prediction process for predictive coding is performed in units of processes called prediction units (PUs). PUs are formed by dividing a CU in one of several division patterns. Further, an orthogonal transform process is performed in units of processes called transform units (TUs). TUs are formed by dividing a CU or a PU to a certain depth.

The division of a CU into blocks is conducted by recursively repeating the division of one block into four (=2×2) subblocks, forming, as a result, a tree structure in a quad-tree shape. A quad-tree as a whole is referred to as a coding tree block (CTB), and a logical unit for CTBs is referred to as a coding tree unit (CTU).

PU is a processing unit of a prediction process including intra-prediction and inter-prediction. PUs are formed by dividing a CU in one of several division patterns. TU is a processing unit of an orthogonal transform process. TUs are formed by dividing a CU (each PU in the CU for intra-CU) to a certain depth. How blocks such as the above CUs, PUs, and TUs are divided to set these blocks in an image is typically determined based on comparison in cost that affects coding efficiency. This PU size, for example, is specified and controlled as a coding control parameter by the coding control part 112.

In the example illustrated in FIG. 3, the image compression device 105 includes a screen rearrangement buffer 132, a calculation section 133, an orthogonal transform section 134, a quantization section 135, a reversible coding section 136, a storage buffer 137, an inverse quantization section 138, an inverse orthogonal transform section 139, and an addition section 140. Also, the image compression device 105 includes a filter 141, a frame memory 144, a switch 145, an intra-prediction section 146, a motion prediction/compensation section 147, a predictive image selection section 148, and a rate control section 149.

In the image compression device 105 illustrated in FIG. 3, image data from the image processing device 104 is output to and stored in the screen rearrangement buffer 132.

The screen rearrangement buffer 132 rearranges frame-by-frame images in the stored display order into a coding order in accordance with a group of pictures (GOP) structure. The screen rearrangement buffer 132 outputs the images, obtained after the rearrangement, to the calculation section 133, the intra-prediction section 146, and the motion prediction/compensation section 147.

The calculation section 133 performs coding by subtracting the predictive image supplied from the predictive image selection section 148 from the image supplied from the screen rearrangement buffer 132. The calculation section 133 outputs the resultant image to the orthogonal transform section 134 as residual information (difference). It should be noted that if a predictive image is not supplied from the predictive image selection section 148, the calculation section 133 outputs the image, read from the screen rearrangement buffer 132, to the orthogonal transform section 134 in an ‘as-is’ fashion as residual information.

The orthogonal transform section 134 performs, on a TU-by-TU basis, an orthogonal transform process on the residual information from the calculation section 133. The orthogonal transform section 134 supplies the result of the orthogonal transform process, obtained after the orthogonal transform process, to the quantization section 135.

The quantization section 135 quantizes the result of the orthogonal transform process supplied from the orthogonal transform section 134. The quantization section 135 supplies the quantization value, obtained as a result of the quantization, to the reversible coding section 136.

The reversible coding section 136 obtains information indicating an optimal intra-prediction mode (hereinafter referred to as intra-prediction mode information) from the intra-prediction section 146. Also, the reversible coding section 136 obtains information indicating an optimal inter-prediction mode (hereinafter referred to as inter-prediction mode information), a motion vector, information identifying a reference image, and so on from the motion prediction/compensation section 147. Also, the reversible coding section 136 obtains offset filter information on an offset filter from the filter 141.

The reversible coding section 136 performs reversible coding such as variable length coding and arithmetic coding on the quantization value supplied from the quantization section 135.

Also, the reversible coding section 136 reversibly codes not only intra-prediction mode information or inter-prediction mode information, the motion vector, and information identifying the reference image but also offset filter information and so on as coding information on coding. The reversible coding section 136 supplies the reversibly coded coding information and quantization value to the storage buffer 137 as coding data for storage.

It should be noted that reversibly coded coding information may be header information (e.g., slice header) of a reversibly coded quantization value.

The storage buffer 137 temporarily stores coded data supplied from the reversible coding section 136. Also, the storage buffer 137 supplies stored coded data to the wireless transmission device 106 as a coded stream.

The quantization value output from the quantization section 135 is also input to the inverse quantization section 138. The inverse quantization section 138 inversely quantizes the quantization value. The inverse quantization section 138 supplies the result of the orthogonal transform process, obtained as a result of the inverse quantization, to the inverse orthogonal transform section 139.

The inverse orthogonal transform section 139 performs, on a TU-by-TU basis, an inverse orthogonal transform process on the result of the orthogonal transform process supplied from the inverse quantization section 138. Among examples of inverse orthogonal transform techniques are inverse discrete cosine transform (IDCT) and inverse discrete sine transform (IDST). The inverse orthogonal transform section 139 supplies residual information, obtained as a result of the inverse orthogonal transform process, to the addition section 140.

The addition section 140 performs decoding by adding the residual information supplied from the inverse orthogonal transform section 139 and the predictive image supplied from the predictive image selection section 148. The addition section 140 supplies the decoded image to the filter 141 and the frame memory 144.

The filter 141 performs a filtering process on the decoded image supplied from the addition section 140. Specifically, the filter 141 sequentially performs a deblocking filtering process and an adaptive offset filtering (sample adaptive offset (SAO)) process. The filter 141 supplies a coded picture, obtained after the filtering process, to the frame memory 144. Also, the filter 141 supplies, to the reversible coding section 136 as offset filter information, information indicating the type of adaptive offset filtering process performed and the offset. The presence or absence of these filters and other information are specified and controlled as coding control parameters by the coding control part 112.

The frame memory 144 stores images supplied from the filter 141 and those supplied from the addition section 140. Of the images that are stored in the frame memory 144 and have yet to undergo the filtering processes, those adjacent to a PU are supplied to the intra-prediction section 146 via the switch 145 as peripheral images. On the other hand, the images that are stored in the frame memory 144 and have undergone the filtering processes are output to the motion prediction/compensation section 147 via the switch 145 as reference images.

The intra-prediction section 146 performs, on a PU-by-PU basis, an intra-prediction process for all possible intra-prediction modes using the peripheral images read from the frame memory 144 via the switch 145.

Also, the intra-prediction section 146 calculates cost function values (details described later) for available intra-prediction modes indicated by the information supplied from a mode table setting section 50 based on the image read from the screen rearrangement buffer 132 and the predictive image generated as a result of the intra-prediction process. Then, the intra-prediction section 146 determines the intra-prediction mode with the smallest cost function value as an optimal intra-prediction mode.

Incidentally, it is important that a proper prediction mode be selected in H.264 and H.265 to achieve a higher coding efficiency.

A method referred to as a joint model (JM) and implemented in AVC's reference software (http://iphome.hhi.de/suehring/tml/index.htm) can be cited as an example of such a selection method.

In a JM, two mode determination methods, high complexity mode and low complexity mode which will be described below, are selectable. Both calculate a cost function value relating to each prediction mode Mode and select the prediction mode with the smallest cost function value as the optimal mode for the block concerned to macroblocks.

The cost function in high complexity mode is expressed by Formula (1) depicted below.

Cost(ModeεΩ)=D+λ*R (1)

Here, Ω is the whole set of potential modes for coding the block concerned to macroblocks, and D is the differential energy between decoded and input images when coding is performed in the prediction mode concerned. λ is the Lagrange undetermined multiplier given as a quantization parameter function. R is the total code amount when coding is performed in the prediction mode concerned including an orthogonal transform factor.

That is, coding in high complexity mode requires a provisional coding process to be performed once in all potential modes to calculate the above parameters D and R, thus requiring a larger amount of computation.

The cost function in low complexity mode is expressed by Formula (2) depicted below.

Cost(ModeεΩ)=D+QP2Quant(QP)*HeaderBit (2)

Here, unlike in high complexity mode, D is the differential energy between the predictive and input images. QP2Quant(QP) is given as a function of a quantization parameter Qp, and HeaderBit is the code amount relating to information that pertains to the Header such as motion vector and mode, not including an orthogonal transform factor.

That is, although a prediction process is required for each of the potential modes in low complexity mode, a decoded image is not necessary, thus making it unnecessary to perform a coding process. For this reason, coding in low complexity mode can be achieved with a smaller amount of computation than in high complexity mode.

The intra-prediction section 146 supplies the predictive image generated in the optimal intra-prediction mode and the associated cost function value to the predictive image selection section 148. When notified of the selection of the predictive image generated in the optimal intra-prediction mode by the predictive image selection section 148, the intra-prediction section 146 supplies intra-prediction mode information to the reversible coding section 136. It should be noted that intra-prediction mode refers to the mode that represents a PU size, a prediction direction, and so on.

The motion prediction/compensation section 147 performs a motion prediction/compensation process in inter-prediction mode. Specifically, the motion prediction/compensation section 147 detects, on a PU-by-PU basis, a motion vector for inter-prediction mode based on the image supplied from the screen rearrangement buffer 132 and the reference image read from the frame memory 144 via the switch 145. Then, the motion prediction/compensation section 147 generates a predictive image by performing, on a PU-by-PU basis, a compensation process on the reference image based on the motion vector. For example, this motion vector search range, motion vector precision, the number of reference planes, and so on are specified and controlled as coding control parameters by the coding control part 112.

At this time, the motion prediction/compensation section 147 calculates cost function values for all the inter-prediction modes based on the image supplied from the screen rearrangement buffer 132 and the predictive image and determines the inter-prediction mode with the smallest cost function value as the optimal inter-prediction mode. Then, the motion prediction/compensation section 147 supplies the cost function value of the optimal inter-prediction mode and the associated predictive image to the predictive image selection section 148. Also, when notified of the selection of the predictive image generated in the optimal inter-prediction mode by the predictive image selection section 148, the motion prediction/compensation section 147 outputs inter-prediction mode information, the associated motion vector, information identifying the reference image, and so on to the reversible coding section 136. It should be noted that inter-prediction mode refers to the mode that represents a PU size and so on.

The predictive image selection section 148 determines, of the optimal intra-prediction mode and the inter-prediction mode, the mode with the smaller associated cost function value, as the optimal prediction mode based on the cost function values supplied from the intra-prediction section 146 and the motion prediction/compensation section 147. Then, the predictive image selection section 148 supplies the predictive image of the optimal prediction mode to the calculation section 133 and the addition section 140. Also, the predictive image selection section 148 notifies the selection of the predictive image of the optimal prediction mode to the intra-prediction section 146 or the motion prediction/compensation section 147.

The rate control section 149 controls a quantization operation rate of the quantization section 135 such that no overflow or underflow occurs based on the coded data stored in the storage buffer 137.

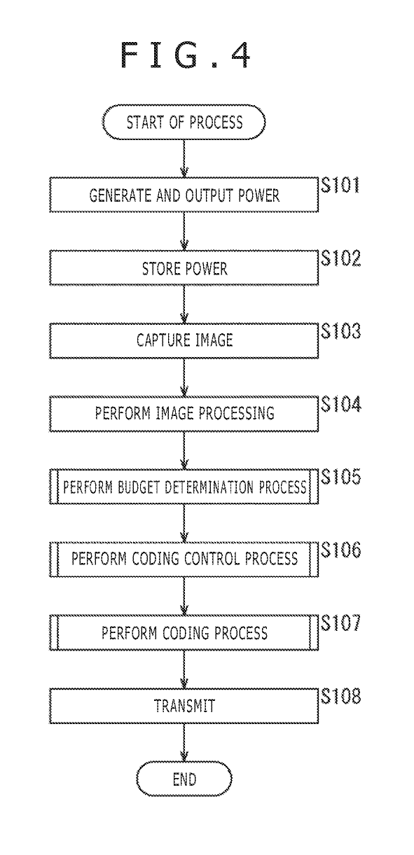

A description will be given next of the processes handled by the camera system 100 with reference to the flowchart illustrated in FIG. 4.

In step S101, the power generation device 101 generates power and outputs power to the power storage device 102. At this time, the power generation device 101 supplies power output information, information on power output, to the budget determination/coding control section 107.

In step S102, the power storage device 102 stores power generated by the power generation device 101. The power storage device 102 supplies remaining battery charge information, information on remaining battery charge, to the budget determination/coding control section 107.

In step S103, the imaging device 103 images a subject and outputs image data, obtained by imaging, to the image processing device 104. In step S104, the image processing device 104 performs image processing on the image data from the imaging device 103 other than image compression such as pixel and color correction and distortion correction and outputs image data subjected to image processing to the image compression device 105.

In step S105, the budget determination part 111 performs a budget determination process. This budget determination process will be described later with reference to FIG. 5, and the process in step S105 classifies current power and wireless communication statuses. Then, classified power/band budget information is supplied to the coding control part 112.

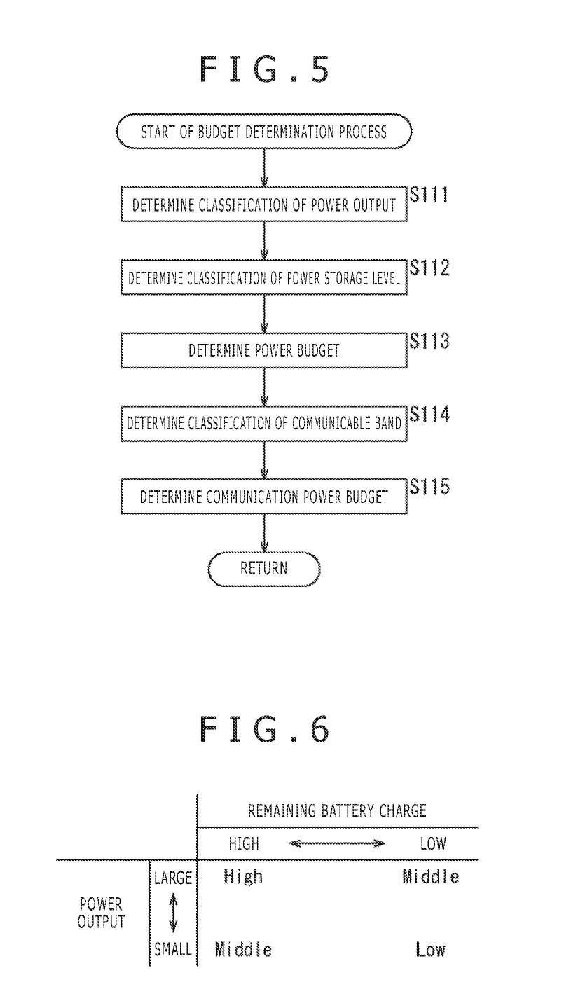

In step S106, the coding control part 112 performs a coding control process based on power/band budget information from the budget determination part 111. This coding control process will be described later with reference to FIG. 6, and the process in step S106 generates an image coding scheme and a coding parameter/mode and supplies, to the image compression device 105, compression control information including the image coding scheme and the coding parameter/mode.

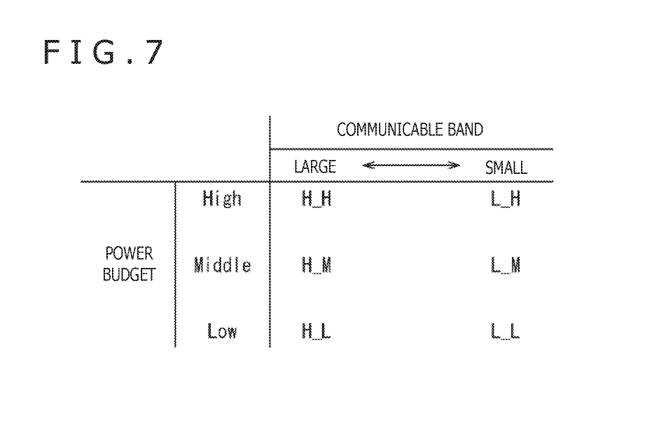

In step S107, the image compression device 105 performs a coding process (image compression process). This coding process will be described later with reference to FIG. 7, and the process in step S107 performs the coding process based on compression control information and outputs image data subjected to image processing to the wireless transmission device 106.

In step S108, the wireless transmission device 106 receives coded data from the image compression device 105 and transmits the data wirelessly via the antenna 108.

A description will be given next of the budget determination process in step S105 in FIG. 4 with reference to FIG. 5.

In step S111, the budget determination part 111 performs a power output classification process based on power output information from the power generation device 101. That is, the budget determination part 111 classifies, using a threshold, the power output as large or small from the power output information from the power generation device 101.

In step S112, the budget determination part 111 performs a power storage level classification process based on remaining battery charge information of the power storage device 102. That is, the budget determination part 111 classifies, using a threshold, the remaining battery charge as high or low from the remaining battery charge information of the power storage device 102.

In step S113, the budget determination part 111 determines the power budget and classifies power budget information, for example, as high, middle, or low as illustrated in FIG. 6.

FIG. 6 illustrates an example of power budget information. The example illustrated in FIG. 6 depicts that when the remaining battery charge is high and the power output is large, the power budget is high, and that when the remaining battery charge is high and the power output is small, the power budget is middle. The example also depicts that when the remaining battery charge is low and the power output is large, the power budget is middle, and that when the remaining battery charge is low and the power output is small, the power budget is low.

In step S114, the budget determination part 111 performs a communicable band classification determination process based on communicable band information from the wireless transmission device 106. That is, the budget determination part 111 classifies, using, for example, a threshold, the communicable band information from the wireless transmission device 106 as having large or small band.

In step S115, the budget determination part 111 determines the communication power budget and classifies power/band budget information, for example, into six types illustrated in FIG. 7.

FIG. 7 illustrates power/band budget information. The example illustrated in FIG. 7 depicts that when the communicable band is large and the power budget is high, the power band budget is H_H, and that when the communicable band is small and the power budget is high, the power band budget is L_H. The example also depicts that when the communicable band is large and the power budget is middle, the power band budget is H_M, and that when the communicable band is small and the power budget is middle, the power band budget is L_M. Further, the example depicts that when the communicable band is large and the power budget is low, the power band budget is H_L, and that when the communicable band is small and the power budget is low, the power band budget is L_L.

Then, the budget determination part 111 supplies power/band budget information indicating this classification to the coding control part 112 and then terminates the budget determination process.

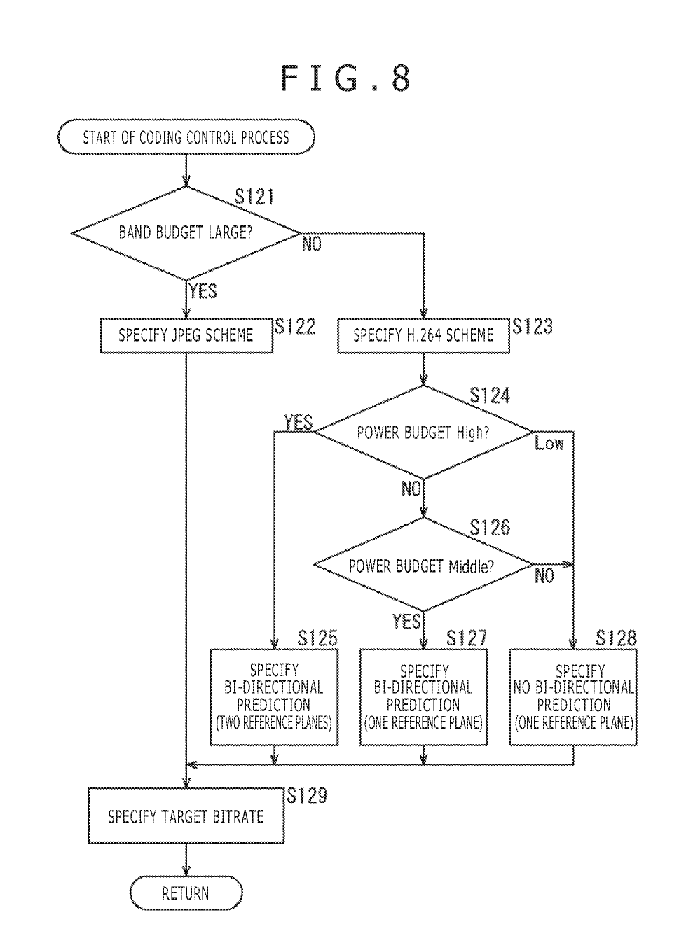

A description will be given next of the coding control process in step S106 in FIG. 4 with reference to the flowchart depicted in FIG. 8.

In step S121, the coding control part 112 determines, based on power/band budget information from the budget determination part 111, whether or not the band budget is large. If it is determined in step S121 that the band budget is large (e.g., H_* in six-type classification), the process proceeds to step S122. In step S122, the coding control part 112 specifies JPEG scheme, an intra-coding scheme, as a coding scheme to use. It should be noted that a scheme other than JPEG such as MotionJPEG may also be used as long as the scheme is an intra-coding scheme.

If it is determined in step S121 that the band budget is small (e.g., L_* in six-type classification), the process proceeds to step S123. In step S123, the coding control part 112 specifies H.264 scheme, a coding scheme that permits inter-prediction offering a higher compression ratio than intra, as a coding scheme to use. It should be noted that MPEG2, MPEG4, VP8, VP9, and H.265 scheme may be used in addition to H.264 scheme as long as the coding scheme permits inter-prediction.

In step S124, the coding control part 112 determines, based on power/band budget information from the budget determination part 111, whether or not the power budget is high to decide on the number of reference planes to use for inter-prediction. If it is determined in step S124 that the power budget is high, the process proceeds to step S125. In step S125, the coding control part 112 specifies two reference planes as planes available for inter-prediction and enables bi-directional prediction.

If it is determined in step S124 that the power budget is not high, the process proceeds to step S126. In step S126, the coding control part 112 determines, based on power/band budget information from the budget determination part 111, whether or not the power budget is middle to decide on the number of reference planes available for inter-prediction.

If it is determined in step S126 that the power budget is middle, the process proceeds to step S127. In step S127, the coding control part 112 specifies one reference plane as a plane available for inter-prediction and enables bi-directional prediction.

If it is determined in step S126 that the power budget is not middle, i.e., low, the process proceeds to step S128. In step S128, the coding control part 112 specifies one reference plane as a plane available for inter-prediction and enables uni-directional prediction although bi-directional prediction cannot be enabled. This ensures reduced power consumption for the coding process.

Following steps S122, S125, S127, and S128, the process proceeds to step S129. In step S129, the coding control part 112 specifies a value equal to the communicable band or lower as a target bitrate.

The image coding scheme and coding parameter/mode calculated as described above are supplied to the image compression device 105 as compression control information. Then, the image compression device 105 proceeds with the coding process in accordance with this compression control information.

It should be noted that, in the case of H.264 scheme, the variable coding process may be switched between CABAC and CAVLC instead of (or in addition to) the above switching process. CABAC requires that coding and decoding be performed while at the same time updating a probability table one bit at a time, resulting in a computation structure that is not easily suited to parallelization. That is, it is necessary to operate the circuit at high speed so as to enhance a throughput (processing capability per unit time). The computation itself is complicated and power-consuming. Instead, CABAC is higher in coding efficiency than CAVLC.

On the other hand, CAVLC has a table lookup computation structure, making the computation structure easy to parallelize. The details of the processes are relatively simple, thus contributing to low power consumption during the processes. Instead, CAVLC is lower in coding efficiency than CABAC. From the above, it is possible to switch so that if the power budget is high (if much power is available which means the clock frequency may be increased), CABAC is used, and that, otherwise, CAVLC is used.

### (Description of Process Handled by Image Compression Device)

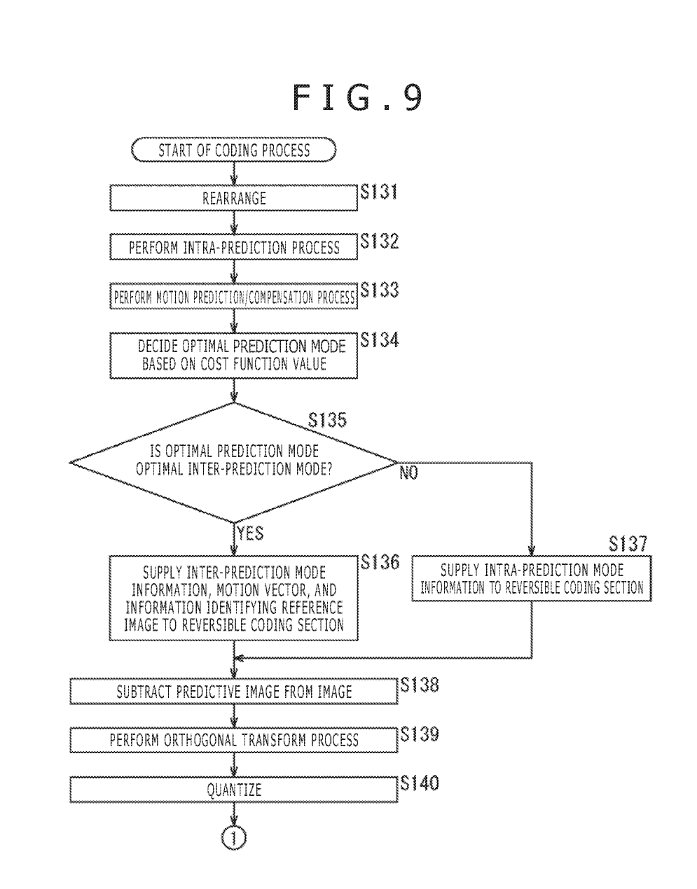

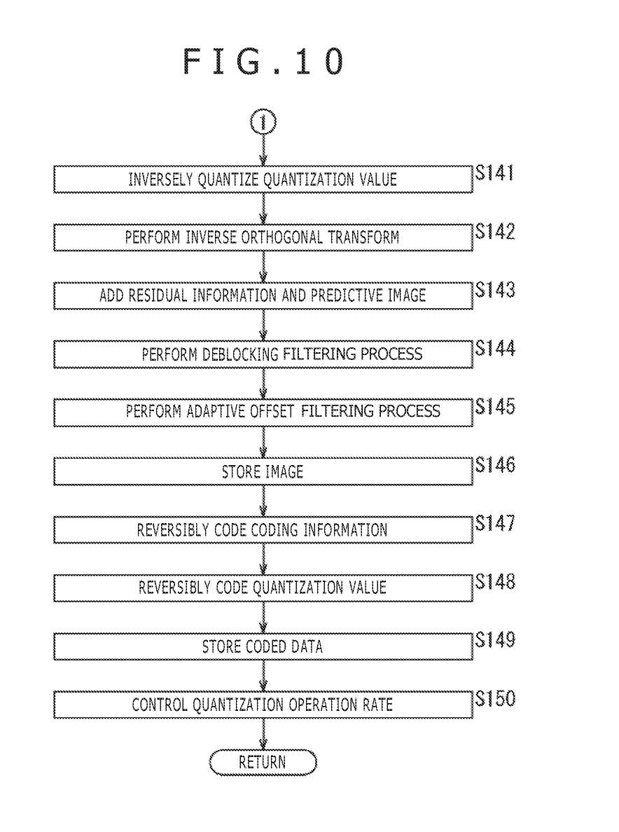

FIGS. 9 and 10 are flowcharts describing a coding process handled by the image compression device 105 illustrated in FIG. 1. It should be noted that this coding process is performed based on compression control information from the coding control part 112. Also, in FIGS. 9 and 10, an example will be described in which the H.265 coding scheme is used as an example.

Image data from the image processing device 104 is output to and stored in the screen rearrangement buffer 132.

In step S131 illustrated in FIG. 9, the screen rearrangement buffer 132 (FIG. 3) of the image compression device 105 rearranges frame images in the stored display order into the coding order in accordance with the GOP structure. The screen rearrangement buffer 132 supplies the frame-by-frame images, obtained after the rearrangement, to the calculation section 133, the intra-prediction section 146, and the motion prediction/compensation section 147.

In step S132, the intra-prediction section 146 performs, on a PU-by-PU basis, an intra-prediction process in intra-prediction modes. That is, the intra-prediction section 146 calculates cost function values for all intra-prediction modes based on the image read from the screen rearrangement buffer 132 and the predictive image generated as a result of the intra-prediction process. Then, the intra-prediction section 146 determines the intra-prediction mode with the smallest cost function value as an optimal intra-prediction mode. The intra-prediction section 146 supplies the predictive image generated in the optimal intra-prediction mode and the associated cost function value to the predictive image selection section 148.

Also, in step S133, the motion prediction/compensation section 147 performs, on a PU-by-PU basis, a motion prediction/compensation process in inter-prediction mode. Also, the motion prediction/compensation section 147 calculates cost function values for all the inter-prediction modes based on the image supplied from the screen rearrangement buffer 132 and the predictive image and determines the inter-prediction mode with the smallest cost function value as the optimal inter-prediction mode. Then, the motion prediction/compensation section 147 supplies the cost function value of the optimal inter-prediction mode and the associated predictive image to the predictive image selection section 148. It should be noted that if H.265-intra only is specified, the process in step S133 is omitted. That is, skipping the unnecessary process ensures reduced power consumption. Also, if this motion vector search range, motion vector precision, the number of reference planes, and so on are specified and controlled as coding control parameters by the coding control part 112, inter-prediction is conducted in accordance with that control.

In step S134, the predictive image selection section 148 determines, of the optimal intra-prediction mode and the inter-prediction mode, the mode with the smaller cost function value, as the optimal prediction mode based on the cost function values supplied from the intra-prediction section 146 and the motion prediction/compensation section 147. Then, the predictive image selection section 148 supplies the predictive image of the optimal prediction mode to the calculation section 133 and the addition section 140.

In step S135, the predictive image selection section 148 determines whether the optimal prediction mode is the optimal inter-prediction mode. If it is determined in step S135 that the optimal prediction mode is the optimal inter-prediction mode, the predictive image selection section 148 notifies the selection of the predictive image generated in the optimal inter-prediction mode to the motion prediction/compensation section 147.

Then, in step S136, the motion prediction/compensation section 147 supplies inter-prediction mode information, a motion vector, and information identifying a reference image to the reversible coding section 136 and causes the process to proceed to step S138.

On the other hand, if it is determined in step S136 that the optimal prediction mode is not the optimal inter-prediction mode, that is, if the optimal prediction mode is the optimal intra-prediction mode, the predictive image selection section 148 notifies the intra-prediction section 146 of the selection of the predictive image generated in the optimal intra-prediction mode. Then, in step S137, the intra-prediction section 146 supplies intra-prediction mode information to the reversible coding section 136 and causes the process to proceed to step S138.

In step S138, the calculation section 133 performs coding by subtracting the predictive image supplied from the predictive image selection section 148 from the image supplied from the screen rearrangement buffer 132. The calculation section 133 outputs the resultant image to the orthogonal transform section 134 as residual information.

In step S139, the orthogonal transform section 134 performs, on a TU-by-TU basis, an orthogonal transform process on the residual information. The orthogonal transform section 134 supplies the result of the orthogonal transform process, obtained after the orthogonal transform process, to the quantization section 135.

In step S140, the quantization section 135 quantizes the result of the orthogonal transform process supplied from the orthogonal transform section 134. The quantization section 135 supplies the quantization value, obtained as a result of the quantization, to the reversible coding section 136 and the inverse quantization section 138.

In step S141, the inverse quantization section 138 inversely quantizes the quantization value from the quantization section 135. The inverse quantization section 138 supplies the result of the orthogonal transform process, obtained as a result of the inverse quantization, to the inverse orthogonal transform section 139.

In step S142, the inverse orthogonal transform section 139 performs, on a TU-by-TU basis, an inverse orthogonal transform process on the result of the orthogonal transform process supplied from the inverse quantization section 138. The inverse orthogonal transform section 139 supplies residual information, obtained as a result of the inverse orthogonal transform process, to the addition section 140.

In step S143, the addition section 140 performs decoding by adding the residual information supplied from the inverse orthogonal transform section 139 and the predictive image supplied from the predictive image selection section 148. The addition section 140 supplies the decoded image to the filter 141 and the frame memory 144.

In step S144, the filter 141 performs a deblocking filtering process on the decoded image supplied from the addition section 140.

In step S145, the filter 141 performs an adaptive offset filtering process on the image that has undergone the deblocking filtering process. The filter 141 supplies the image, obtained as a result thereof, to the frame memory 144. Also, the filter 141 supplies offset filter information to the reversible coding section 136 for each LCU. The presence or absence of these filters and other information are specified and controlled as coding control parameters by the coding control part 112. Therefore, if the deblocking filter is not enabled, the process in step S144 is omitted, and if an adaptive offset filter is not enabled, the process in step S145 is omitted. This ensures reduced power consumption required for the coding process.

In step S146, the frame memory 144 stores the images supplied from the filter 141 and the addition section 140. Of the images that are stored in the frame memory 144 and have yet to undergo the filtering processes, those adjacent to a PU are supplied to the intra-prediction section 146 via the switch 145 as peripheral images. On the other hand, the images that are stored in the frame memory 144 and have undergone the filtering processes are output to the motion prediction/compensation section 147 via the switch 145 as reference images.

In step S147, the reversible coding section 136 reversibly codes not only intra-prediction mode information or inter-prediction mode information, the motion vector, and information identifying the reference image but also offset filter information and so on as coding information.

In step S148, the reversible coding section 136 reversibly codes the quantization value supplied from the quantization section 135. Then, the reversible coding section 136 generates coded data from the coding information reversibly coded in the process in step S147 and the reversibly coded quantization value and supplies the coding information and the quantization value to the storage buffer 137.

In step S149, the storage buffer 137 temporarily stores coded data supplied from the reversible coding section 136.

In step S150, the rate control section 149 controls the quantization operation rate of the quantization section 135 such that no overflow or underflow occurs based on the coded data stored in the storage buffer 137.

It should be noted that numerous variations are possible for the coding control process.

A description will be given next of another example of the coding control process in step S106 of FIG. 4 with reference to the flowchart illustrated in FIG. 11.

In step S161, the coding control part 112 determines, based on power/band budget information from the budget determination part 111, whether or not the band budget is large. If it is determined in step S161 that the band budget is large, the process proceeds to step S162. In step S162, the coding control part 112 specifies H.264 intra-picture only as a coding scheme to use. It should be noted that a scheme other than H.264 such as MPEG2, MPEG4, VP8, VP9, and H.265 intra-picture may also be used as long as the scheme is an intra-picture coding scheme that permits inter-prediction.

If it is determined in step S161 that the band budget is small, the process proceeds to step S163. In step S163, the coding control part 112 specifies H.264 scheme, a coding scheme that permits inter-prediction offering a higher compression ratio than intra, as a coding scheme to use. It should be noted that MPEG2, MPEG4, VP8, VP9, and H.265 scheme may be used in addition to H.264 scheme as long as the coding scheme permits inter-prediction.

In step S164, the coding control part 112 determines, based on power/band budget information from the budget determination part 111, whether or not the power budget is high to decide on the motion prediction search range for inter-prediction. If it is determined in step S164 that the power budget is high, the process proceeds to step S165. In step S165, the coding control part 112 specifies a large motion prediction search range for inter-prediction and, in step S166, enables the deblocking filter.

If it is determined in step S164 that the power budget is not high, the process proceeds to step S167. In step S167, the coding control part 112 determines, based on power/band budget information from the budget determination part 111, whether or not the power budget is middle to decide on the motion prediction search range for inter-prediction.

If it is determined in step S167 that the power budget is middle, the process proceeds to step S168. In step S168, the coding control part 112 specifies a medium motion prediction search range for inter-prediction and enables the deblocking filter in step S169.

If it is determined in step S167 that the power budget is not middle, i.e., low, the process proceeds to step S170. In step S170, the coding control part 112 specifies a small motion prediction search range for inter-prediction and disables the deblocking filter in step S171. This ensures reduced power consumption required for the coding process.

Following steps S162, S166, S169, and S171, the process proceeds to step S172. In step S172, the coding control part 112 specifies a value equal to the communicable band or lower as a target bitrate.

The image coding scheme and coding parameter/mode calculated as described above are supplied to the image compression device 105 as compression control information. Then, the image compression device 105 proceeds with the coding process in accordance with this compression control information.

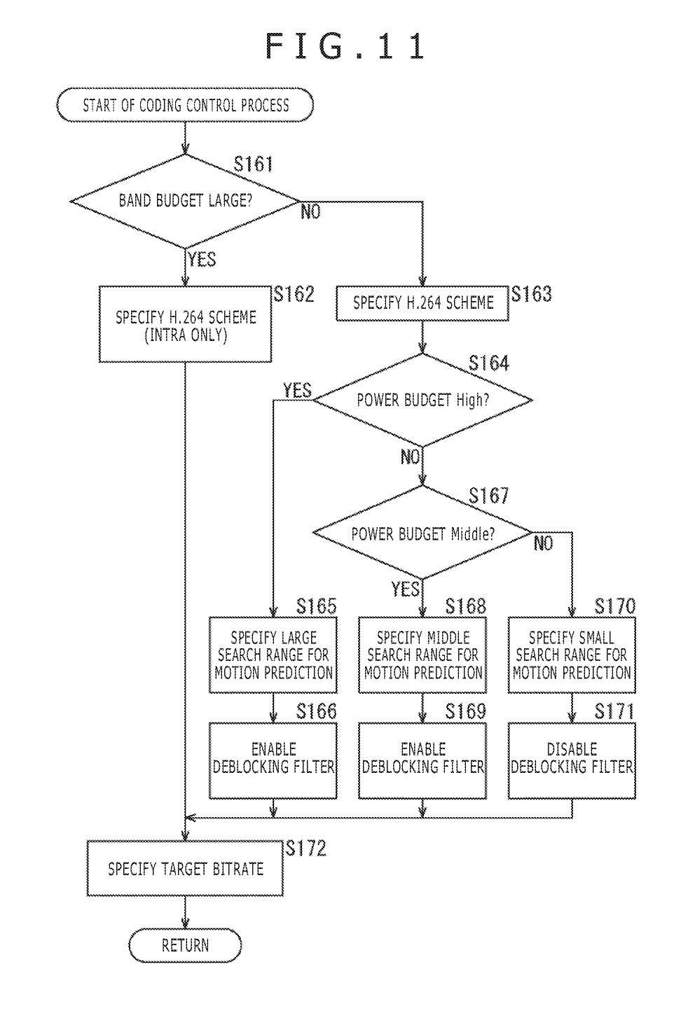

A description will be given next of still another example of the coding control process in step S106 of FIG. 4 with reference to the flowchart illustrated in FIG. 12.

In step S181, the coding control part 112 determines, based on power/band budget information from the budget determination part 111, whether or not the band budget is large. If it is determined in step S181 that the band budget is large, the process proceeds to step S182. In step S182, the coding control part 112 specifies H.265 intra-picture only as a coding scheme to use.

In step S183, the coding control part 112 determines, based on power/band budget information from the budget determination part 111, whether or not the power budget is high. If it is determined in step S183 that the power budget is high, the process proceeds to step S184. In step S184, the coding control part 112 enables the deblocking filter and, in step S185, enables the adaptive offset filter.

If it is determined in step S183 that the power budget is not high, the process proceeds to step S186. In step S186, the coding control part 112 determines, based on power/band budget information from the budget determination part 111, whether or not the power budget is middle.

If it is determined in step S186 that the power budget is middle, the process proceeds to step S187. In step S187, the coding control part 112 enables the deblocking filter and disables the adaptive offset filter in step S188.

If it is determined in step S186 that the power budget is not middle, i.e., low, the process proceeds to step S189. In step S189, the coding control part 112 disables the deblocking filter and, in step S190, disables the adaptive offset filter. This ensures reduced power consumption required for the coding process.

If it is determined in step S181 that the band budget is small, the process proceeds to step S191. In step S191, the coding control part 112 specifies H.265 scheme, a coding scheme that permits inter-prediction offering a higher compression ratio than intra, as a coding scheme to use.

In step S192, the coding control part 112 determines, based on power/band budget information from the budget determination part 111, whether or not the power budget is high to decide on the motion prediction search range for inter-prediction. If it is determined in step S192 that the power budget is high, the process proceeds to step S193. In step S193, the coding control part 112 specifies a large motion prediction search range for inter-prediction, enables the deblocking filter in step S194, and enables the adaptive offset filter in step S195.

If it is determined in step S192 that the power budget is not high, the process proceeds to step S196. In step S196, the coding control part 112 determines, based on power/band budget information from the budget determination part 111, whether or not the power budget is middle to decide on the motion prediction search range for inter-prediction.

If it is determined in step S196 that the power budget is middle, the process proceeds to step S197. In step S197, the coding control part 112 specifies a medium motion prediction search range for inter-prediction, enables the deblocking filter in step S198, and disables the adaptive offset filter in step S199. This ensures lower power consumption required for the coding process than when the power budget is high.

If it is determined in step S196 that the power budget is not middle, i.e., low, the process proceeds to step S200. In step S200, the coding control part 112 specifies a small motion prediction search range for inter-prediction, disables in step S201, the deblocking filter, and disables, in step S202, the adaptive offset filter. This ensures lower power consumption required for the coding process than when the power budget is middle.

Following steps S185, S188, S190, S195, S199, and S202, the process proceeds to step S203. In step S203, the coding control part 112 specifies a value equal to the communicable band or lower as a target bitrate.

The image coding scheme and coding parameter/mode calculated as described above are supplied to the image compression device 105 as compression control information. Then, the image compression device 105 proceeds with the coding process in accordance with this compression control information.

Here, another possible determination example for budget determination is one for determining power budget based only on remaining charge information of power storage level. For example, a system having no natural energy-based power generation device determines the power budget based only on remaining charge of a storage or primary battery as does a camera system 200 which will be described later.

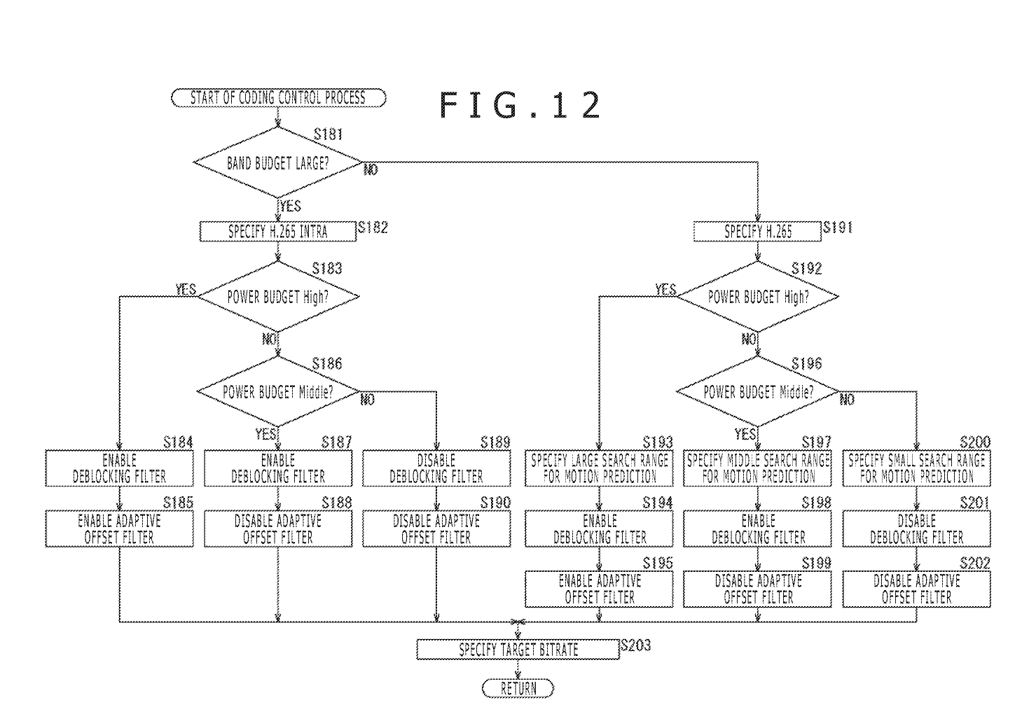

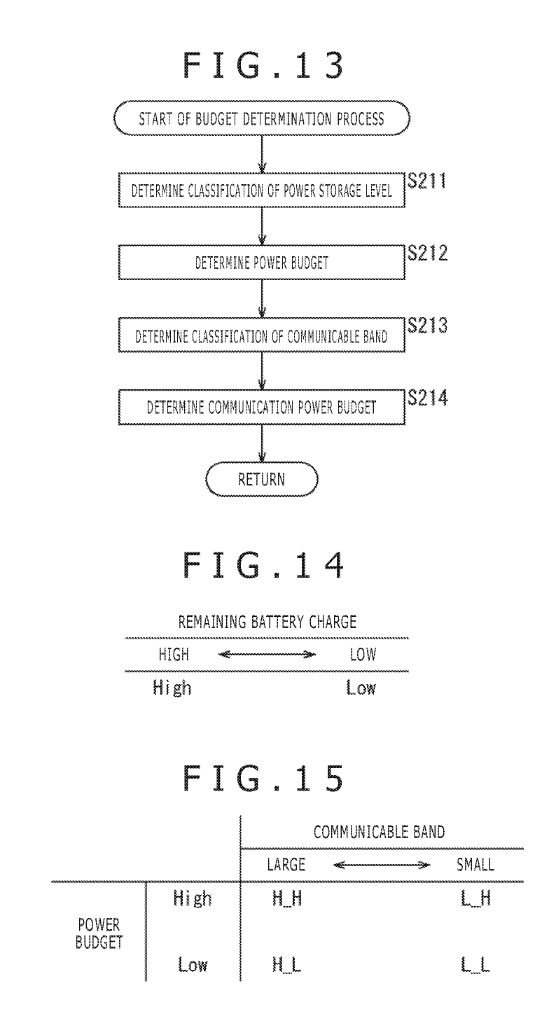

As an example of such a budget determination process, a description will be given next of another example of the budget determination process in step S105 in FIG. 4 with reference to the flowchart in FIG. 13.

In step S211, the budget determination part 111 performs a power storage level classification process based on remaining battery charge information of the power storage device 102. That is, the budget determination part 111 classifies, using a threshold, the remaining battery charge as high or low from the remaining battery charge information of the power storage device 102.

In step S212, the budget determination part 111 determines the power budget and classifies power budget information, for example, as high or low.

FIG. 14 illustrates an example of power budget information. The example illustrated in FIG. 14 depicts that when the remaining battery charge is high, the power budget is high, and that when the remaining battery charge is low, the power budget is low.

In step S213, the budget determination part 111 performs a communicable band classification determination process based on communicable band information from the wireless transmission device 106. That is, the budget determination part 111 classifies, using, for example, a threshold, the communicable band information from the wireless transmission device 106 as having large or small band.

In step S214, the budget determination part 111 determines the communication power budget and classifies power/band budget information, for example, into four types illustrated in FIG. 15.

FIG. 15 illustrates an example of power/band budget information. The example illustrated in FIG. 15 depicts that when the communicable band is large and the power budget is high, the power band budget is H_H, and that when the communicable band is small and the power budget is low, the power band budget is L_H. The power budget determination table also depicts that when the communicable band is large and the power budget is low, the power band budget is H_L, and that when the communicable band is small and the power budget is low, the power band budget is L_L.

Then, the budget determination part 111 supplies power/band budget information indicating this classification to the coding control part 112 and terminates the budget determination process.

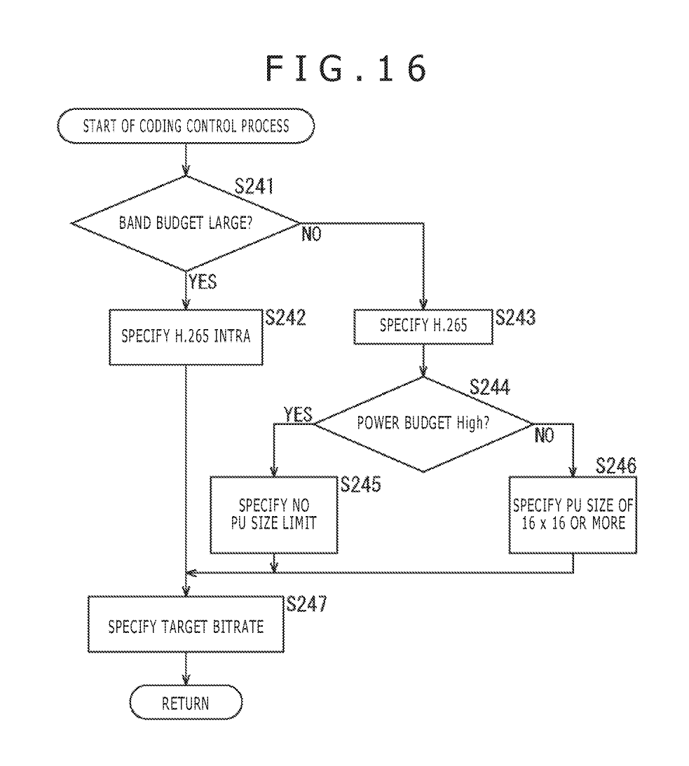

A description will be given next of the coding control process in step S106 in FIG. 4 when the budget determination process illustrated in FIG. 13 is performed with reference to the flowchart in FIG. 16.

In step S241, the coding control part 112 determines, based on power/band budget information from the budget determination part 111, whether or not the band budget is large. If it is determined in step S241 that the band budget is large, the process proceeds to step S242. In step S242, the coding control part 112 specifies H.265 intra-picture only as a coding scheme to use.

If it is determined in step S241 that the band budget is small, the process proceeds to step S243. In step S243, the coding control part 112 specifies H.265 scheme, a coding scheme that permits inter-prediction offering a higher compression ratio than intra, as a coding scheme to use.

In step S244, the coding control part 112 determines, based on power/band budget information from the budget determination part 111, whether or not the power budget is high. If it is determined in step S244 that the power budget is high, the process proceeds to step S245. In step S245, the coding control part 112 specifies no limitation as PU size limitation.

If it is determined in step S244 that the power budget is not high, the process proceeds to step S246. In step S246, the coding control part 112 limits the PU size such that the PU size is 16×16 or more. This prevents the PU size from becoming too small, thus ensuring lower power consumption required for the coding process than when the power budget is high.

Following steps S242, S245, and S246, the process proceeds to step S247. In step S247, the coding control part 112 specifies a value equal to the communicable band or lower as a target bitrate.

The image coding scheme and coding parameter/mode calculated as described above are supplied to the image compression device 105 as compression control information. Then, the image compression device 105 proceeds with the coding process in accordance with this compression control information.

Also, here, another possible determination example for budget determination is one for determining budget based only on power or band budget. This example is applicable to a system that is powered from a wired power network and transmits data wirelessly, for example, as does a camera system 300 which will be described later or to a system that is powered by a natural energy-based power generation device and transmits data in a wired fashion, for example, as does a camera system 400.

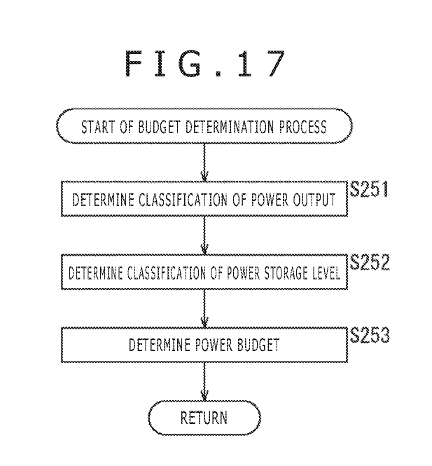

As an example of budget determination process for determining budget based only on power budget, a description will be given next of still another example of the budget determination process in step S105 in FIG. 4 with reference to the flowchart in FIG. 17.

In step S251, the budget determination part 111 performs a power output classification process based on power output information from the power generation device 101. That is, the budget determination part 111 classifies, using a threshold, the power output as large or small from the power output information from the power generation device 101.

In step S252, the budget determination part 111 performs a power storage level classification process based on remaining battery charge information of the power storage device 102. That is, the budget determination part 111 classifies, using a threshold, the remaining battery charge as high or low from the remaining battery charge information of the power storage device 102.

In step S253, the budget determination part 111 determines the power budget and classifies power budget information, for example, as high, middle, or low. Then, the budget determination part 111 supplies power budget information indicating this classification to the coding control part 112 and terminates the budget determination process.

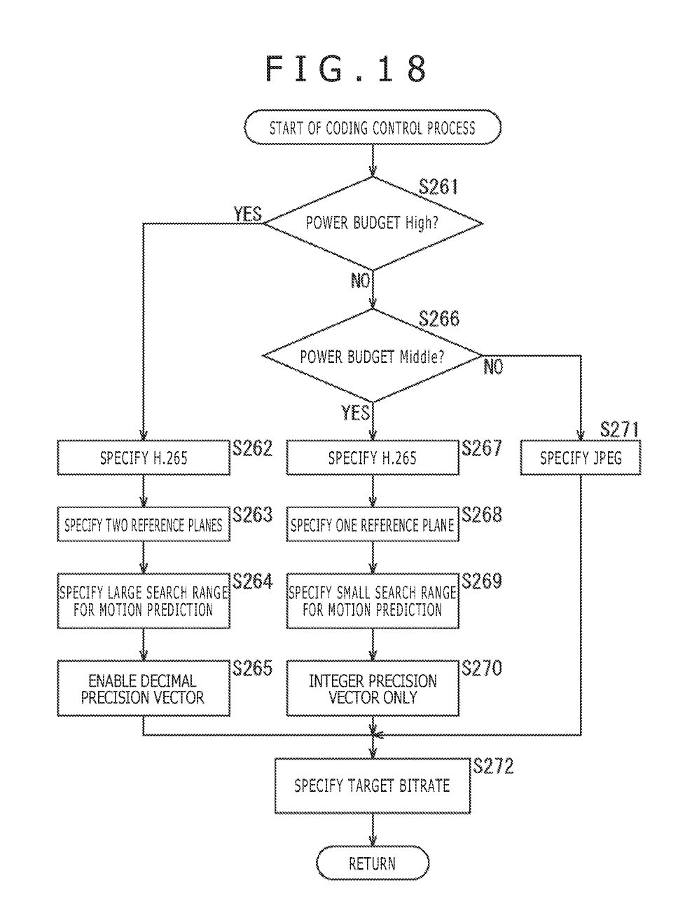

A description will be given next of the coding control process in step S106 in FIG. 4 when the budget determination process illustrated in FIG. 17 is performed with reference to the flowchart in FIG. 18.

In step S261, the coding control part 112 determines, based on power budget information from the budget determination part 111, whether or not the power budget is high. If it is determined in step S261 that the power budget is high, the process proceeds to step S262. In step S262, the coding control part 112 specifies H.265 as a coding scheme to use.

In step S263, the coding control part 112 specifies two reference planes as planes available for inter-prediction and enables bi-directional prediction.

In step S264, the coding control part 112 specifies a large motion prediction search range for inter-prediction and, in step S265, enables a decimal precision vector by specifying decimal precision (½ or ¼) as motion vector search precision for motion prediction.

If it is determined in step S244 that the power budget is not high, the process proceeds to step S266. In step S266, the coding control part 112 determines, based on power budget information from the budget determination part 111, whether or not the power budget is middle.

If it is determined in step S266 that the power budget is middle, the process proceeds to step S267. In step S267, the coding control part 112 specifies H.265 scheme as a coding scheme to use. In step S268, the coding control part 112 specifies one reference plane as a plane available for inter-prediction and enables bi-directional prediction. In step S269, the coding control part 112 specifies a small motion prediction search range for inter-prediction and, in step S270, enables only an integer precision vector by specifying integer precision as motion vector search precision for motion prediction. This ensures lower power consumption required for the coding process than when the power budget is high.

If it is determined in step S266 that the power budget is not middle, i.e., low, the process proceeds to step S271. In step S271, the coding control part 112 specifies JPEG as a coding scheme. This ensures lower power consumption required for the coding process than when the power budget is middle.

Following steps S265, S270, and S271, the process proceeds to step S272. In step S272, the coding control part 112 specifies a value equal to the communicable band or lower as a target bitrate.

The image coding scheme and coding parameter/mode calculated as described above are supplied to the image compression device 105 as compression control information. Then, the image compression device 105 proceeds with the coding process in accordance with this compression control information.

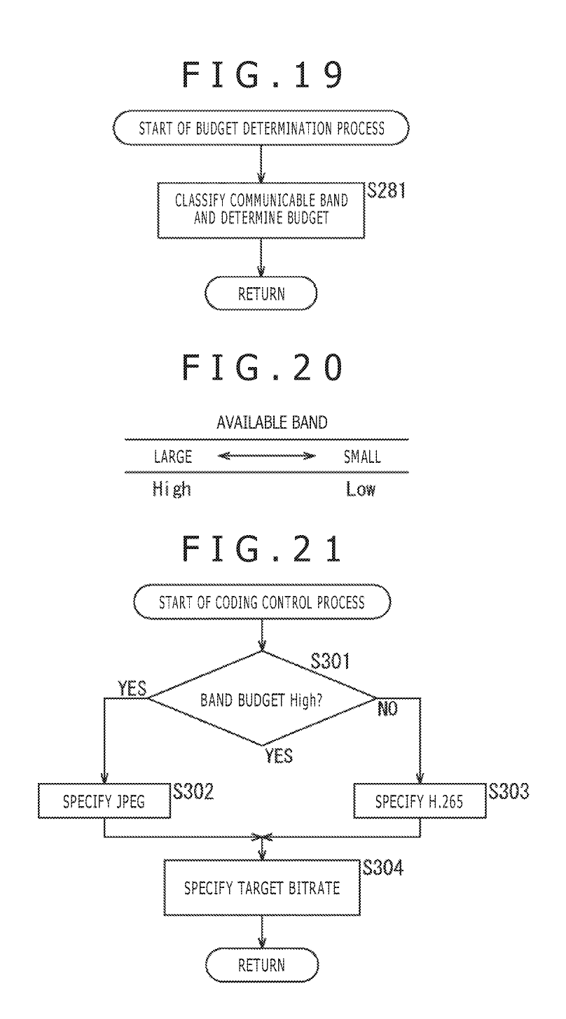

As an example of budget determination process for determining budget based only on communication budget, a description will be given next of still another example of the budget determination process in step S105 in FIG. 4 with reference to the flowchart in FIG. 19.

In step S281, the budget determination part 111 performs a communicable band classification budget determination process based on communicable band information from the wireless transmission device 106. That is, the budget determination part 111 classifies, using, for example, a threshold, the communicable band information from the wireless transmission device 106 as high or low illustrated in FIG. 20.

FIG. 20 illustrates an example of band budget information. The example illustrated in FIG. 20 depicts that when the available band is large, the band budget is high, and that when the available band is small, the band budget is low.

Then, the budget determination part 111 supplies band budget information indicating this classification to the coding control part 112 and terminates the budget determination process.

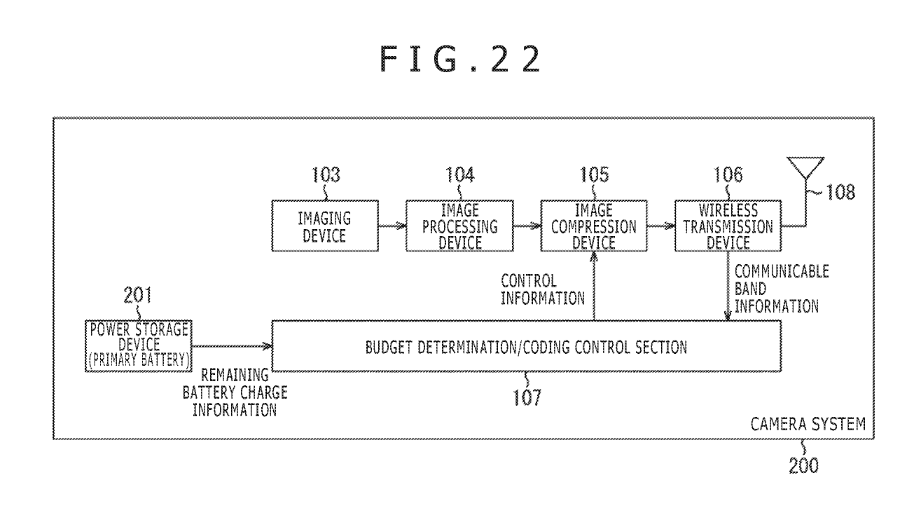

A description will be given next of the coding control process in step S106 in FIG. 4 when the budget determination process illustrated in FIG. 19 is performed with reference to the flowchart in FIG. 21.

The coding control part 112 determines, based on band budget information from the budget determination part 111, whether or not the band budget is large. If it is determined in step S301 that the band budget is large, the process proceeds to step S302. In step S302, the coding control part 112 specifies JPEG scheme, an intra-coding scheme, as a coding scheme to use. It should be noted that a scheme other than JPEG such as MotionJPEG may also be used as long as the scheme is an intra-coding scheme.

On the other hand, if it is determined in step S301 that the band budget is small, the process proceeds to step S303. In step S303, the coding control part 112 specifies H.265 scheme, a coding scheme that permits inter-prediction offering a higher compression ratio than intra, as a coding scheme to use. It should be noted that MPEG2, MPEG4, VP8, VP9, and H.264 scheme may be used in addition to H.265 scheme as long as the coding scheme permits inter-prediction.

Following steps S302 and S303, the process proceeds to step S304. In step S304, the coding control part 112 specifies a value equal to the communicable band or lower as a target bitrate.

As described above, in a camera system which makes at least one of available power and communicable band change, the present technology allows for the compression ratio to be changed, coding data to be downsized, and power consumption to be reduced by changing (or switching between) the coding schemes and coding control parameters. This permits stable transfer of high-integrity image data for long hours. It is also possible to transfer high-integrity image data for long hours without lowering the image resolution and update frequency.

### 2. Second Embodiment

### (Configuration Example of Camera System)

FIG. 22 is a block diagram illustrating another configuration example of the camera system to which the present technology is applied.

The camera system 200 is common to the camera system 100 illustrated in FIG. 1 in that the camera system 200 includes the imaging device 103, the image processing device 104, the image compression device 105, the wireless transmission device 106, and the budget determination/coding control section 107. The camera system 200 is different from the camera system 100 illustrated in FIG. 1 in that the power generation device 101 has been removed and that the power storage device 102 has been replaced with a power storage device (primary battery) 201.

That is, the power storage device (primary battery) 201 includes a power storage or primary battery and supplies remaining battery charge information indicating remaining battery charge to the budget determination/coding control section 107.

Therefore, the budget determination/coding control section 107 includes no natural energy-based power generation device and determines the power budget based only on remaining battery charge information from the power storage device (primary battery) 201 as described with reference to FIG. 13. The budget determination/coding control section 107 also performs the coding control process as described above with reference to FIG. 16.

It should be noted that other processes are the same as those for the camera system 100 described above and that detailed description thereof is omitted.

### 3. Third Embodiment

### (Configuration Example of Camera System)

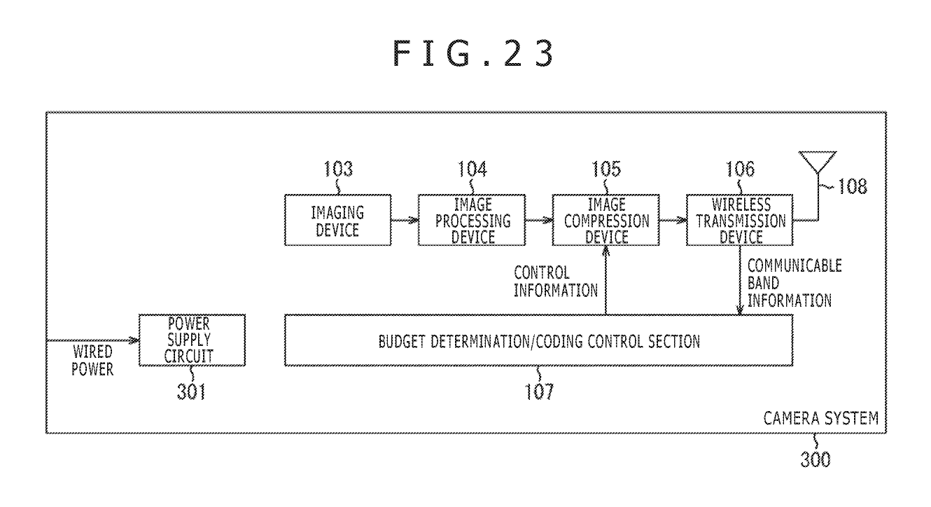

FIG. 23 is a block diagram illustrating another configuration example of the camera system to which the present technology is applied.

The camera system 300 is common to the camera system 100 illustrated in FIG. 1 in that the camera system 300 includes the imaging device 103, the image processing device 104, the image compression device 105, the wireless transmission device 106, and the budget determination/coding control section 107. The camera system 300 is different from the camera system 100 illustrated in FIG. 1 in that the power generation device 101 has been removed and that the power storage device 102 has been replaced with a power supply circuit 301.

That is, the power supply circuit 301 receives wired power and supplies power to the camera system 300. It should be noted that the power supply circuit 301 does not supply remaining battery charge information, information on remaining battery charge, to the budget determination/coding control section 107.

Therefore, the budget determination/coding control section 107 proceeds with the budget determination that is made based only on communication budget as described with reference to FIG. 19. The budget determination/coding control section 107 also performs the coding control process as described above with reference to FIG. 20.

It should be noted that other processes are the same as those for the camera system 100 described above and that detailed description thereof is omitted.

### 4. Fourth Embodiment

### (Configuration Example of Camera System)

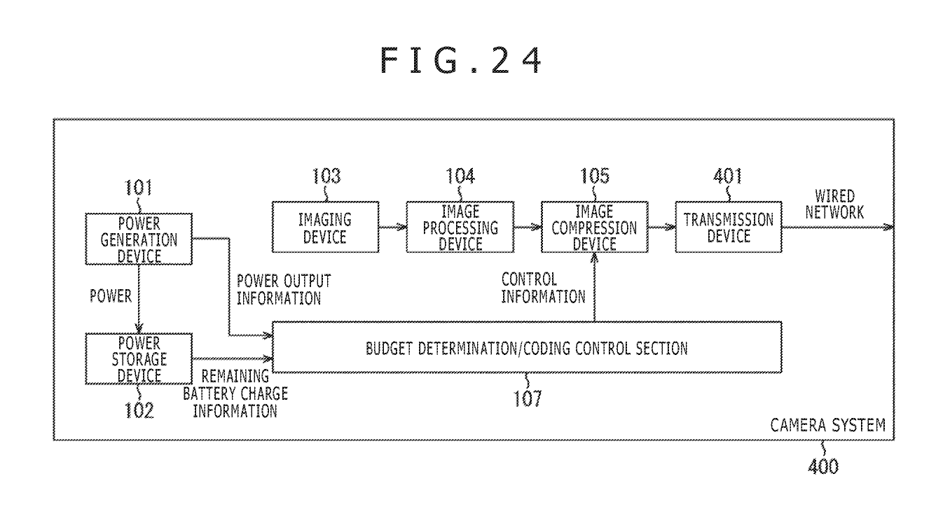

FIG. 24 is a block diagram illustrating another configuration example of the camera system to which the present technology is applied.

The camera system 400 is common to the camera system 100 illustrated in FIG. 1 in that the camera system 400 includes the power generation device 101, the power storage device 102, the imaging device 103, the image processing device 104, the image compression device 105, and the budget determination/coding control section 107. The camera system 400 is different from the camera system 100 illustrated in FIG. 1 in that the wireless transmission device 106 has been replaced with a transmission device 401.

That is, the transmission device 401 receives coded data from the image compression device 105 and transmits coded data via the antenna 108 in a wired fashion. It should be noted that the transmission device 401 does not supply communicable band information to the budget determination/coding control section 107.

Therefore, the budget determination/coding control section 107 proceeds with the budget determination that is made based only on power budget as described with reference to FIG. 21. The budget determination/coding control section 107 also performs the coding control process as described above with reference to FIG. 22.

It should be noted that other processes are the same as those for the camera system 100 described above and that detailed description thereof is omitted.

Although, in the above description, examples of camera systems including at least one of the power generation device 101, the power storage device 102, and the wireless transmission device 106 were described, the present technology is applied not only to imaging devices such as camera systems but also to imaging processing devices and information processing devices that include at least one of power generation, power storage, and wireless transmission devices and handle a coding process.

The present technology is also applicable, for example, to a server such as cloud system that receives information from a device including power generation, power storage, and wireless transmission devices, that handles only the budget determination and coding control processes described above altogether, and that transfers coding control information via the Internet.

### 5. Fifth Embodiment

(Description of Computer to which Present Disclosure is Applied)

The series of processes described above may be performed by hardware or software. If the series of processes are performed by software, the program making up the software is installed to a computer. Here, the computer includes a computer incorporated in dedicated hardware, a general-purpose personal computer capable of performing various functions as various programs are installed thereto, and so on.

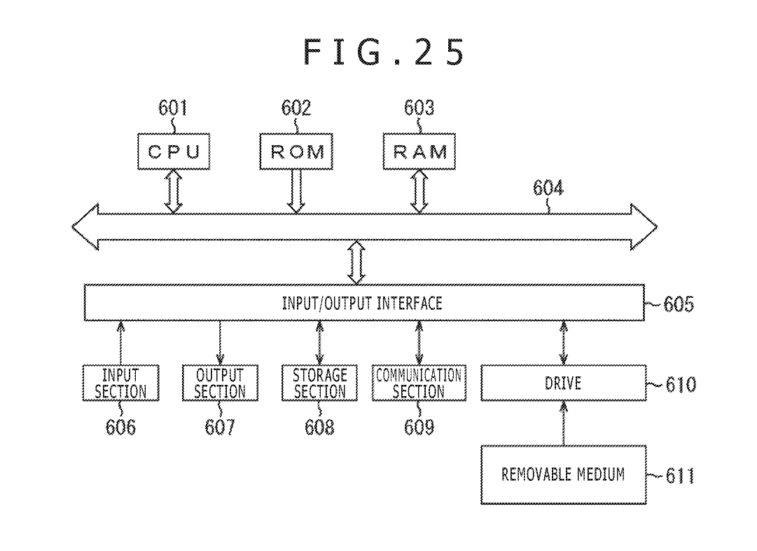

FIG. 25 is a block diagram illustrating a hardware configuration example of a computer that performs the above series of processes using a program.

In the computer, a CPU 601, a read only memory (ROM) 602, a random access memory (RAM) 603 are connected to each other by a bus 604.

An input/output (I/O) interface 605 is further connected to the bus 604. An input section 606, an output section 607, a storage section 608, a communication section 609, and a drive 610 are connected to the I/O interface 605.

The input section 606 includes a keyboard, a mouse, a microphone, and so on. The output section 607 includes a display, a speaker, and so on. The storage section 608 includes a hard disk, a non-volatile memory, and so on. The communication section 609 includes a network interface and so on. The drive 610 drives a removable medium 611 such as magnetic disk, optical disk, magneto-optical disk, or semiconductor memory.

In the computer configured as described above, the CPU 601 performs the above series of processes, for example, by loading the program stored in the storage section 608 into the RAM 603 via the I/O interface 605 and bus 604 for execution.

The program executed by the computer (CPU 601) can be provided in a manner recorded in the removable medium 611, for example, as a packaged medium. Alternatively, the program can be provided via a wired or wireless transmission medium such as local area network, the Internet, digital broadcasting, and so on.

In the computer, the program can be installed to the storage section 608 via the I/O interface 605 as the removable medium 611 is inserted into the drive 610. Alternatively, the program can be received by the communication section 609 via a wired or wireless transmission medium and installed to the storage section 608. In addition to the above, the program can be installed, in advance, to the ROM 602 or the storage section 608.

It should be noted that the program executed by the computer may perform the processes chronologically according to the sequence described in the present specification, or in parallel, or at a necessary time as when the program is called.

Also, in the present specification, the system refers to a set of a plurality of components (e.g., devices, modules (parts), and so on), and whether or not all the components are contained in the same housing does not matter. Therefore, a plurality of devices accommodated in separate housings and connected via a network and a single device having a plurality of modules accommodated in a single housing are both systems.

The effects described in the present specification are merely illustrative and not restrictive, and other effects are allowed.

It should be noted that embodiments of the present disclosure are not limited to those described above and can be modified in various ways without departing from the gist of the present disclosure.

For example, the present disclosure can have a cloud computing configuration in which one function is processed by a plurality of devices via a network in a shared and cooperative manner.

Also, each of the steps described in the above flowcharts can be performed not only by a single device but also by a plurality of devices in a shared manner.

Further, if one step includes a plurality of processes, the plurality of processes included in the one step can be performed not only by a single device but also by a plurality of devices in a shared manner.

Thus, preferred embodiments of the present disclosure have been described in detail with reference to the drawings. However, the present disclosure is not limited to these examples. It is apparent that a person having normal knowledge in the technical field to which the present disclosure pertains can conceive of various changes and modifications within the scope of the technical concept described in the claims and that these are also naturally acknowledged as belonging to the technical scope of the present disclosure.

It should be noted that the present technology can also have the following configurations:
(1) An image coding device includes a coding section adapted to generate coded data by performing a coding process on image data, a coding control section adapted to control the coding process in accordance with power information on power, and a transmission section adapted to transmit coded data generated by the coding section.
(2) The image coding device of feature (1), in which the power information includes at least one of information indicating a power output generated and remaining battery charge information of a battery that stores power.
(3) The image coding device of feature (1) or (2), in which the coding control section switches between coding schemes used for the coding process.
(4) The image coding device of any one of features (1) to (3), in which the coding control section switches between intra-prediction and inter-prediction for the coding scheme used for the coding process.
(5) The image coding device of any one of features (1) to (4), in which the coding control section switches between coding control parameters used for the coding process.
(6) The image coding device of feature (5), in which the coding control section switches between a uni-directional prediction mode and a bi-directional prediction mode as the coding control parameter if inter-prediction is used.
(7) The image coding device of feature (5) or (6), in which the coding control section switches between numbers of reference planes as the coding control parameter if inter-prediction is used.
(8) The image coding device of any one of features (5) to (7), in which the coding control section switches between sizes of a motion prediction search range as the coding control parameter if inter-prediction is used.
(9) The image coding device of any one of features (5) to (8), in which the coding control section switches between motion vector search precision for motion prediction as the coding control parameter if inter-prediction is used.
(10) The image coding device of any one of features (5) to (9), in which the coding control section switches between enabling and disabling the deblocking filter as the coding control parameter.
(11) The image coding device of any one of features (5) to (10), in which the coding control section switches between enabling and disabling at least one of a deblocking filter and an adaptive offset filter as the coding control parameter.
(12) The image coding device of any one of features (5) to (11), in which the coding control section switches a variable length coding process between CABAC and CAVLC as the coding control parameter.
(13) The image coding device of any one of features (5) to (12), in which the coding control section switches between lower limits of a predictive block size as the coding control parameter.
(14) The image coding device of any one of features (1) to (13), in which the transmission section wirelessly transmits coded data generated by the coding section, and the coding control section controls the coding process in accordance with information representing a band over which the transmission section can communicate.
(15) An image coding method causing an image coding device to generate coded data by performing a coding process on image data, control the coding process in accordance with power information, and transmit generated coded data.

### REFERENCE SIGNS LIST

100 Camera system, 101 Power generation device, 102 Power storage device, 103 Imaging device, 104 Image processing device, 105 Image compression device, 106 Wireless transmission device, 107 Budget determination/coding control section, 111 Budget determination part, 112 Coding control part, 200 Camera system, 201 Power storage device (primary battery), 300 Camera system, 301 Power supply circuit, 400 Camera system, 401 Transmission device

1. An image coding device comprising:
a coding section adapted to generate coded data by performing a coding process on image data;
a coding control section adapted to control the coding process in accordance with power information on power; and
a transmission section adapted to transmit coded data generated by the coding section.

2. The image coding device of claim 1, wherein
the power information includes at least one of information indicating a power output generated and remaining battery charge information of a battery that stores power.

3. The image coding device of claim 1, wherein
the coding control section switches between coding schemes used for the coding process.

4. The image coding device of claim 3, wherein
the coding control section switches between intra-prediction and inter-prediction for the coding scheme used for the coding process.

5. The image coding device of claim 1, wherein
the coding control section switches between coding control parameters used for the coding process.

6. The image coding device of claim 5, wherein
the coding control section switches between a uni-directional prediction mode and a bi-directional prediction mode as the coding control parameter if inter-prediction is used.

7. The image coding device of claim 5, wherein
the coding control section switches between numbers of reference planes as the coding control parameter if inter-prediction is used.

8. The image coding device of claim 5, wherein
the coding control section switches between sizes of a motion prediction search range as the coding control parameter if inter-prediction is used.

9. The image coding device of claim 5, wherein
the coding control section switches between motion vector search precision for motion prediction as the coding control parameter if inter-prediction is used.

10. The image coding device of claim 5, wherein
the coding control section switches between enabling and disabling the deblocking filter as the coding control parameter.

11. The image coding device of claim 5, wherein
the coding control section switches between enabling and disabling at least one of a deblocking filter and an adaptive offset filter as the coding control parameter.

12. The image coding device of claim 5, wherein
the coding control section switches a variable length coding process between context-adaptive binary arithmetic coding and context-adaptive variable length coding as the coding control parameter.

13. The image coding device of claim 5, wherein
the coding control section switches between lower limits of a predictive block size as the coding control parameter.

14. The image coding device of claim 1, wherein
the transmission section wirelessly transmits coded data generated by the coding section, and
the coding control section controls the coding process in accordance with information representing a band over which the transmission section can communicate.

15. An image coding method causing an image coding device to:
generate coded data by performing a coding process on image data;
control the coding process in accordance with power information; and
transmit generated coded data.
